(19) United States
(12) Patent Application Publication
(10) Pub. No.: US 2026/0213038 A1
(43) Pub. Date: Jul. 23, 2026

(54) WIRE HARNESS

(71) Applicant: Yazaki Corporation, Tokyo (JP)

(72) Inventors: Katsunori SATO, Shizuoka (JP); Tatsuya OGA, Shizuoka (JP)

(73) Assignee: Yazaki Corporation, Tokyo (JP)

(21) Appl. No.: 19/569,187

(22) Filed: Mar. 17, 2026

Related U.S. Application Data
(63) Continuation of application No. PCT/JP2025/004306, filed on Feb. 10, 2025.

(30) Foreign Application Priority Data
Mar. 14, 2024 (JP) 2024-039845

(51) Int. Cl. H01B 7/00; H01B 7/08

(52) U.S. Cl. CPC H01B 7/0045; H01B 7/08

(57) ABSTRACT

A wire harness includes: a flat wiring member; a first case that accommodates a first portion of the flat wiring member; and a second case that accommodates a second portion. The first portion and the second portion extend in a same extending direction. The first case includes: a first support wall that supports the first portion; and a first side wall erected from the first support wall and extending in the extending direction. The second case includes: a second support wall that supports the second portion; and a second side wall erected from the second support wall and extending in the extending direction. The first side wall has a gap that divides the first side wall into first piece portions aligned in the extending direction. The second side wall is inserted into the gap and aligned on the line same as the line of the plurality of first piece portions.

### CROSS-REFERENCE TO RELATED APPLICATION(S)

This application is a continuation application of International Application PCT/JP2025/004306, filed on Feb. 10, 2025 which claims the benefit of priority from Japanese Patent Application No. 2024-039845 filed on Mar. 14, 2024 and designating the U.S., the entire contents of which are incorporated herein by reference.

### BACKGROUND OF THE INVENTION

### 1. Field of the Invention

The present invention relates to a wire harness.

### 2. Description of the Related Art

There are conventionally known flat wiring members such as a flexible printed circuit board. Japanese Patent Application Laid-open No. 2015-170699 discloses a flexible printed circuit board capable of easily implementing elongated wire arrangement. The flexible printed circuit board of Japanese Patent Application Laid-open No. 2015-170699 includes: a first band-shaped member and a second band-shaped member each having a conductive portion and an insulating portion covering the conductive portion; and a first coupling member that couples a first end of the first band-shaped member and a first end of the second band-shaped member to each other.

Here, there has been a study of accommodating one part of a long flat wiring member in a first case and accommodating another part in a second case. When accommodating one flat wiring member in two cases, there is a need to set the shape of the flat wiring member in consideration of the gap between the two cases, and this is likely to cause reduction in the yield of the flat wiring member. In a wire harness including a flat wiring member and two cases, the yield of the flat wiring member is desirably to be improved.

### SUMMARY OF THE INVENTION

An object of the present invention is to provide a wire harness capable of improving the yield of the flat wiring member.

To achieve the above-described objective, a wire harness according to one aspect of the present invention includes a flat wiring member including a first portion, a second portion, and an intermediate portion; a first case that accommodates the first portion; a second case that accommodates the second portion; wherein the first portion and the second portion extend in a same extending direction and are aligned in a width direction orthogonal to the extending direction, the intermediate portion connects an end of the first portion and an end of the second portion to each other along the width direction, the first case includes: a first support wall that supports the first portion; and a first side wall that is erected from the first support wall and extends in the extending direction, the second case includes: a second support wall that supports the second portion; and a second side wall that is erected from the second support wall and extends in the extending direction, the first side wall has a gap that divides the first side wall into a plurality of first piece portions aligned in the extending direction, and the second side wall is inserted into the gap and is aligned on a same line as the plurality of first piece portions.

According to another aspect of the present invention, in the wire harness, it is preferable that the second side wall has a gap that divides the second side wall into a plurality of second piece portions aligned in the extending direction, each of the first piece portions is inserted between two of the second piece portions, the two being adjacent to each other, and each of the second piece portions is inserted between two of the first piece portions, the two being adjacent to each other.

According to still another aspect of the present invention, in the wire harness, it is preferable that the flat wiring member has a slit formed between the first portion and the second portion and extending in the extending direction, and the flat wiring member is disposed so as to sandwich the first side wall and the second side wall by the first portion and the second portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a wire harness according to an embodiment;

FIG. 2 is a plan view of a flat wiring member according to the embodiment;

FIG. 3 is a plan view of a first case and a second case according to the embodiment;

FIG. 4 is a perspective view of the first case and the second case according to the embodiment;

FIG. 5 is a perspective view of the first case and the second case according to the embodiment;

FIG. 6 is a perspective view of the wire harness according to the embodiment;

FIG. 7 is a plan view of the wire harness according to the embodiment;

FIG. 8 is a plan view of the wire harness according to the embodiment;

FIG. 9 is a cross-sectional view of the wire harness according to the embodiment;

FIG. 10 is a perspective view of the wire harness according to the embodiment; and

FIG. 11 is a perspective view of the wire harness according to the embodiment.

### DETAILED DESCRIPTION OF THE PREFERRED EMBODIMENTS

Hereinafter, a wire harness according to an embodiment of the present invention will be described in detail with reference to the drawings. Note that the present invention is not limited by the embodiment. Moreover, components in the following embodiment include those that are easily conceivable for those skilled in the art or substantially identical.

### Embodiment

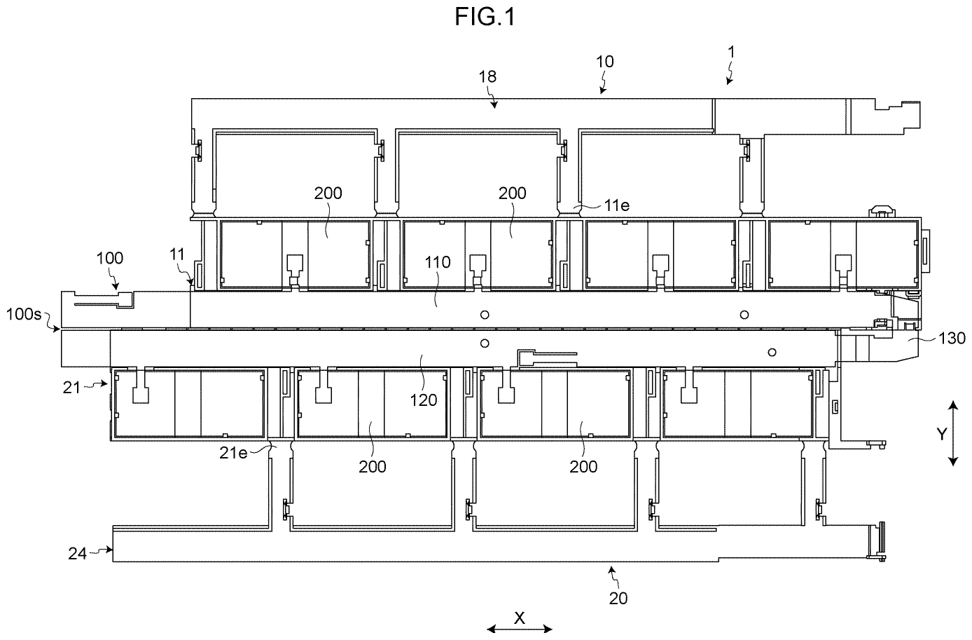

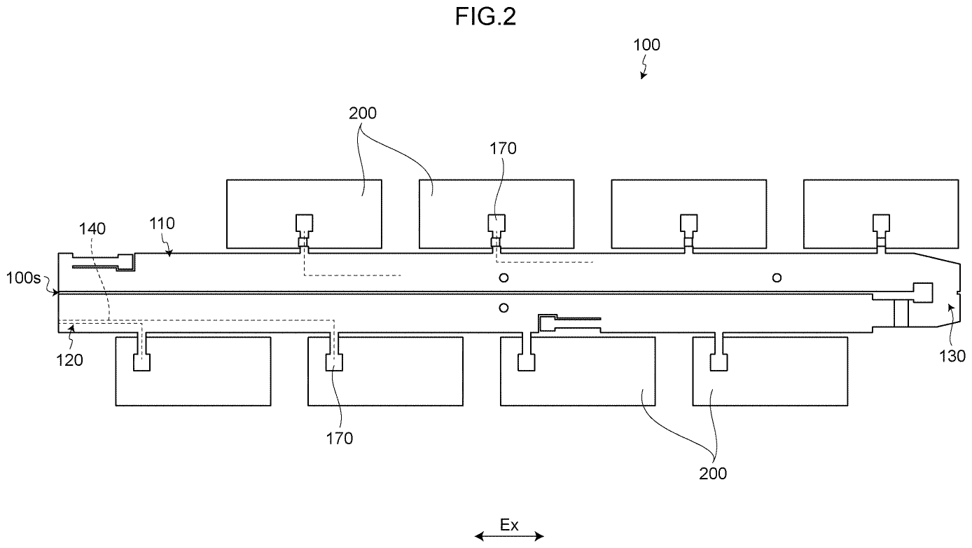

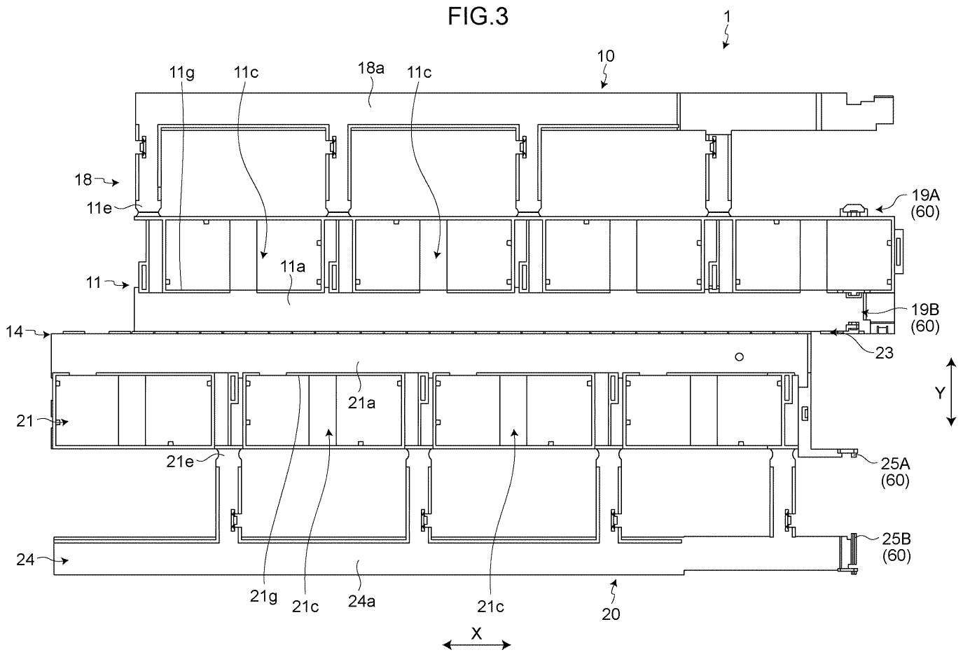

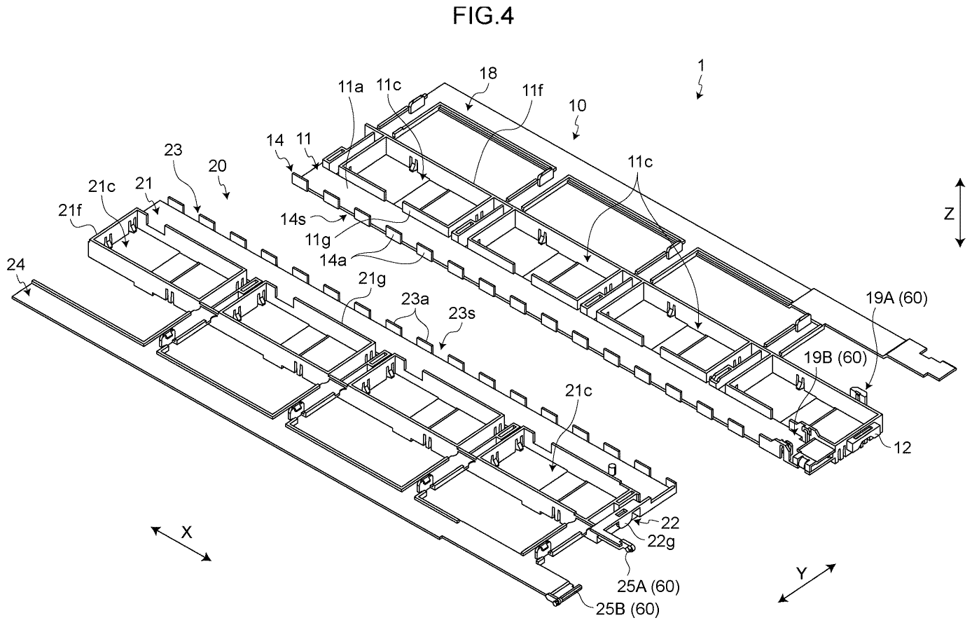

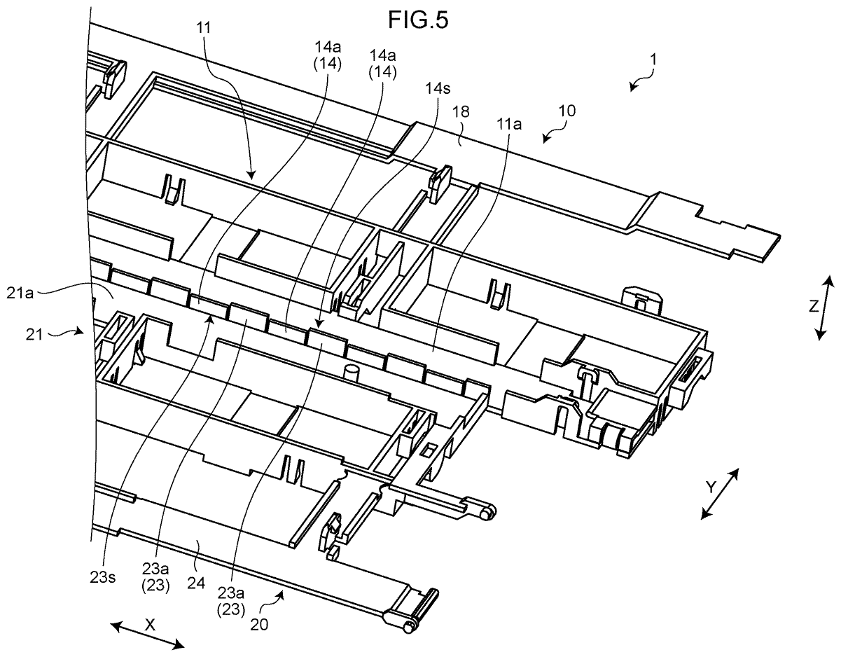

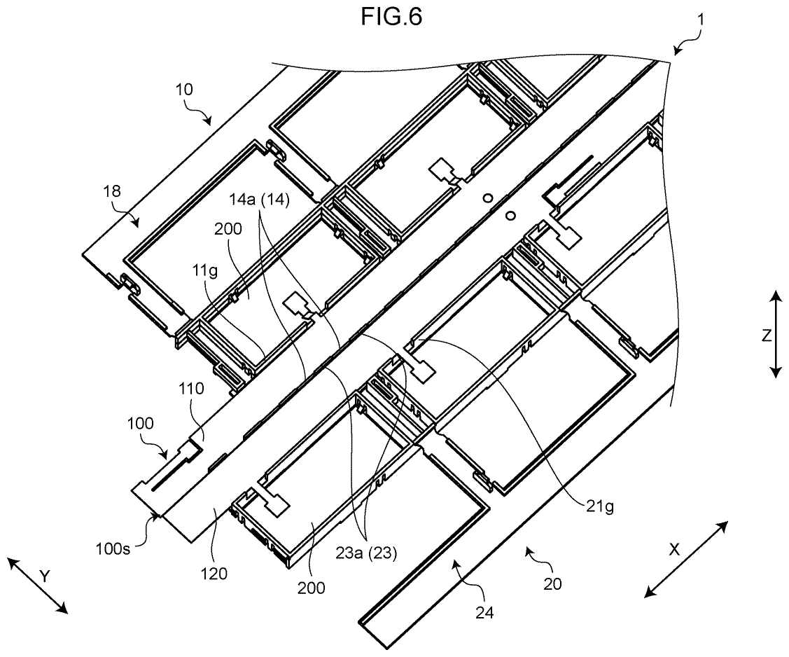

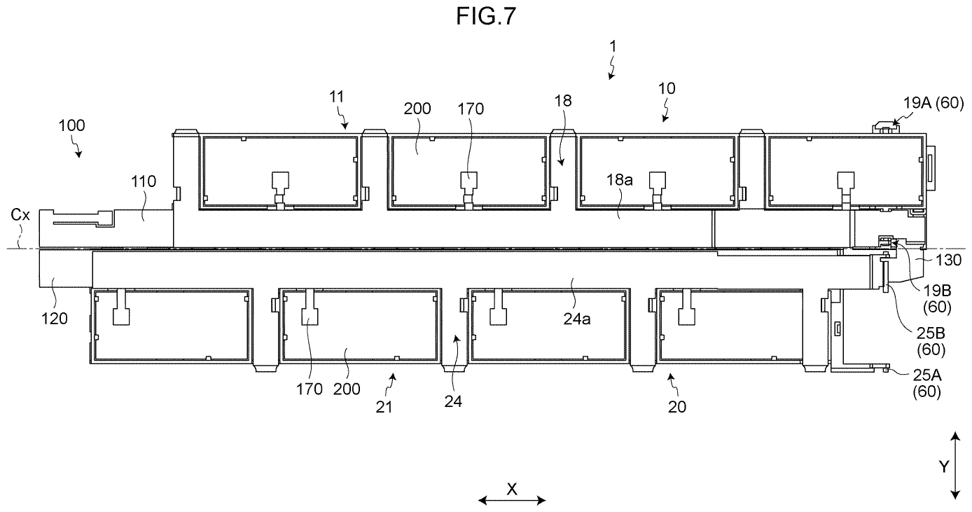

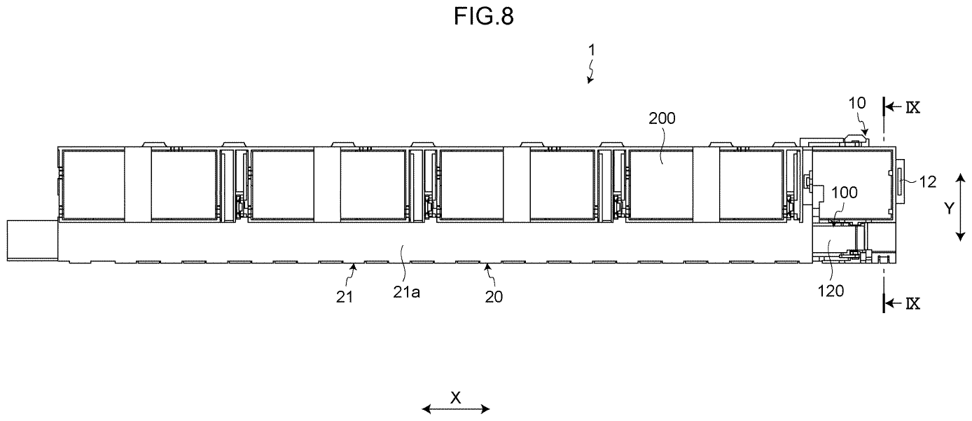

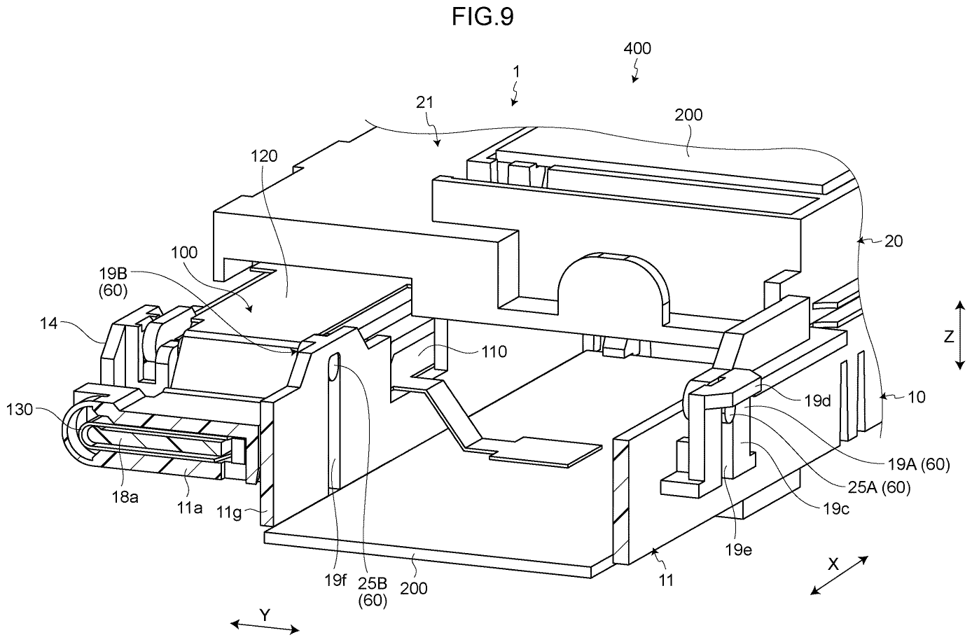

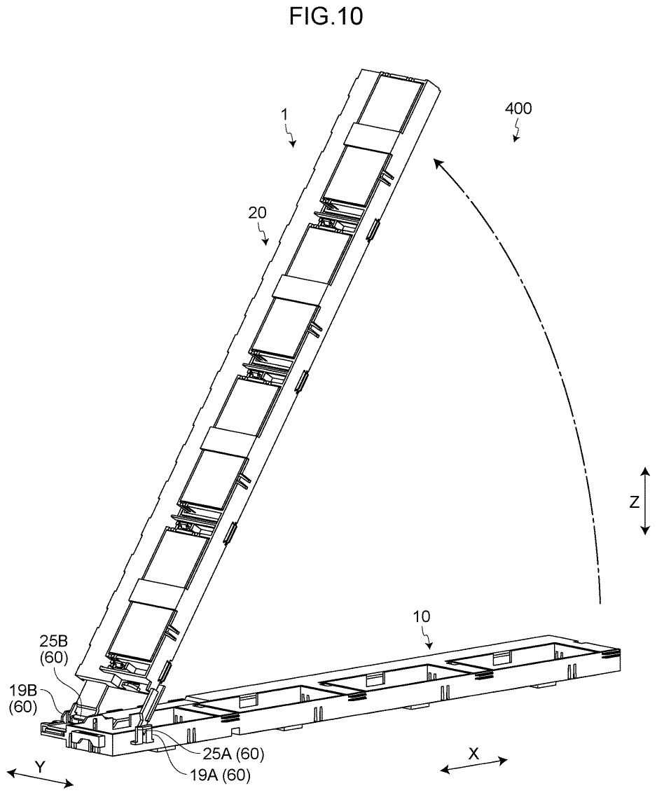

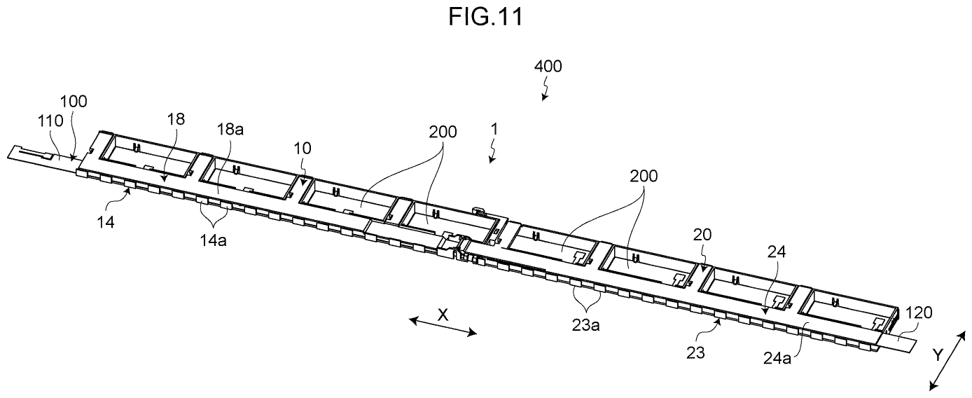

An embodiment will be described with reference to FIGS. 1 to 11. The present embodiment relates to a wire harness. FIG. 1 is a plan view of a wire harness according to an embodiment, FIG. 2 is a plan view of a flat wiring member according to the embodiment, FIG. 3 is a plan view of a first case and a second case according to the embodiment, FIGS. 4 and 5 are perspective views of the first case and the second case according to the embodiment, FIG. 6 is a perspective view of the wire harness according to the embodiment, FIGS. 7 and 8 are plan views of the wire harness according to the embodiment, FIG. 9 is a cross-sectional view of the wire harness according to the embodiment, and FIGS. 10 and 11 are perspective views of the wire harness according to the embodiment.

As illustrated in FIG. 1, a wire harness 1 of the present embodiment includes a flat wiring member 100, a first case 10, and a second case 20. The wire harness 1 may further include a plurality of busbars 200. The wire harness 1 is applied to a battery pack mounted on a vehicle, for example. In this case, each of the busbars 200 is connected to an electrode of a battery cell included in the battery pack.

The flat wiring member 100 of the present embodiment includes a first portion 110, a second portion 120, and an intermediate portion 130. The first portion 110 and the second portion 120 extend in the same extending direction X and are aligned in a width direction Y orthogonal to the extending direction X. The intermediate portion 130 connects an end of the first portion 110 and an end of the second portion 120 to each other in the width direction Y. The flat wiring member 100 has a slit 100s extending in the extending direction X so as to partition the first portion 110 and the second portion 120 from each other.

The first case 10 is a case that accommodates and holds the first portion 110 of the flat wiring member 100. The second case 20 is a case that accommodates and holds the second portion 120 of the flat wiring member 100. The first case 10 and the second case 20 are molded using an insulating synthetic resin, for example.

In FIG. 1, the two cases 10 and 20 are aligned in the width direction Y. In the present specification, regarding the first case 10 and the second case 20, a relative position in which the two cases 10 and 20 are aligned in the width direction Y is denoted as a first relative position. As described below, the two cases 10 and 20 of the present embodiment can minimize the distance between the first case 10 and the second case 20 in the first relative position and the gap between the two cases 10 and 20. This can decrease the width needed in the slit 100s, making it possible to improve the yield of the flat wiring member 100.

As illustrated in FIG. 2, the flat wiring member 100 of the present embodiment has a substantially U shape in plan view. The first portion 110 and the second portion 120 in plan view have substantially rectangular shapes. The intermediate portion 130 in plan view has a substantially trapezoidal shape. The intermediate portion 130 has a tapered shape whose width narrows as being farther away from the first portion 110 and the second portion 120 in the extending direction X.

The flat wiring member 100 has a branch portion 170 connected to the busbar 200. The branch portion 170 extends in the width direction Y from the first portion 110 and the second portion 120. The distal end of the branch portion 170 is connected to the busbar 200 by solder, etc.

The flat wiring member 100 is, for example, a flexible printed circuit board (FPC). When the flat wiring member 100 is an FPC, the flat wiring member 100 includes a base film, a conductive layer, and a coverlay. The conductive layer is sandwiched and protected by the base film and the coverlay. The conductive layer is, for example, a conductive metal foil, and has a circuit pattern including a plurality of detection lines 140. The flat wiring member 100 has flexibility and can be bent to be wired. The flat wiring member 100 has a detection line 140 extending from the first portion 110 to the second portion 120 via the intermediate portion 130.

For example, electronic components such as a fuse or a thermistor, or metal plate components are mounted on the flat wiring member 100. The flat wiring member 100 having a U shape enables higher efficiency of a mounting process for mounting various components and cost reduction. The plurality of busbars 200 are attached to the flat wiring member 100 in FIG. 2. The busbars 200 are disposed along the first portion 110 and the second portion 120 individually. The busbars 200 are disposed at intervals in the extending direction X.

As illustrated in FIGS. 3 and 4, the first case 10 includes a main body 11 and a cover 18. The main body 11 and the cover 18 are integrally molded, for example. In the illustrated first case 10, the main body 11 and the cover 18 are connected to each other via a hinge portion 11e. The main body 11 includes a first support wall 11a, a first side wall 14, and a plurality of holding portions 11c. The first support wall 11a is a wall portion that supports the first portion 110 of the flat wiring member 100. The first support wall 11a has a flat plate shape and extends in the extending direction X.

The first side wall 14 is erected from the first support wall 11a and extends in the extending direction X. The first side wall 14 is disposed at an end of the first support wall 11a in the width direction Y. The first side wall 14 is an outer wall of the first case 10 and is located at an end of the first case 10 in the width direction Y. As illustrated in FIG. 4, the first side wall 14 is divided into a plurality of first piece portions 14a. The plurality of first piece portions 14a are arranged in a line at intervals in the extending direction X. That is, the first side wall 14 has a gap 14s that divides the first side wall 14 into a plurality of first piece portions 14a aligned in the extending direction X.

The holding portion 11c holds the busbar 200. The holding portion 11c in plan view has a substantially rectangular shape. The holding portion 11c has a peripheral wall 11f having a substantially C shape. The peripheral wall 11f may have a projection that locks the busbar 200. The peripheral wall 11f includes a facing wall 11g that faces the first side wall 14. The facing wall 11g faces the first side wall 14 in the width direction Y across the first support wall 11a. The facing wall 11g has a cut through which the branch portion 170 of the flat wiring member 100 can pass.

As illustrated in FIG. 3, the cover 18 has a facing wall 18a that covers the first support wall 11a. The first portion 110 of the flat wiring member 100 is accommodated and held between the first support wall 11a and the facing wall 18a.

The second case 20 includes a main body 21 and a cover 24. The main body 21 and the cover 24 are integrally molded, for example. In the illustrated second case 20, the main body 21 and the cover 24 are connected to each other via a hinge portion 21e. The main body 21 includes a second support wall 21a, a second side wall 23, and a plurality of holding portions 21c. The second support wall 21a is a wall portion that supports the second portion 120 of the flat wiring member 100. The second support wall 21a has a flat plate shape and extends in the extending direction X.

The second side wall 23 is erected from the second support wall 21a and extends in the extending direction X. The second side wall 23 is disposed at an end of the second support wall 21a in the width direction Y. The second side wall 23 is an outer wall of the second case 20 and is located at an end of the second case 20 in the width direction Y. As illustrated in FIG. 4, the second side wall 23 is divided into a plurality of second piece portions 23a. The plurality of second piece portions 23a are arranged in a line at intervals in the extending direction X. That is, the second side wall 23 has a gap 23s that divides the second side wall 23 into a plurality of second piece portions 23a aligned in the extending direction X.

As illustrated in FIG. 4, the first case 10 includes a first engagement portion 12, and the second case 20 includes a second engagement portion 22. The first engagement portion 12 is disposed at an end of the main body 11 in the extending direction X. The second engagement portion 22 is disposed at an end of the main body 21 in the extending direction X. The two engagement portions 12 and 22 are engaged with each other in a second relative position illustrated in FIG. 11.

FIG. 5 illustrates the first case 10 and the second case 20 positioned in the first relative position. The first case 10 and the second case 20 are disposed such that the first support wall 11a and the second support wall 21a are aligned in the width direction Y. At this time, the cover 18 of the first case 10 is located at an end on a side farther from the second case 20. The cover 24 of the second case 20 is located at an end on a side farther from the first case 10.

As illustrated in FIG. 5, the two cases 10 and 20 are disposed so as to allow the first side wall 14 and the second side wall 23 to mesh with each other. The second piece portion 23a of the second side wall 23 is inserted into the gap 14s of the first side wall 14. In other words, the second piece portion 23a is inserted between two of the first piece portions 14a, the two first piece portions 14a being adjacent to each other. In the illustrated wire harness 1, the dimension of the gap 14s in the extending direction X is equal to the width of the second piece portion 23a or slightly larger than the width of the second piece portion 23a. Therefore, the second piece portion 23a enters between the two first piece portions 14a and meshes with the first side wall 14.

The first piece portion 14a of the first side wall 14 is inserted into the gap 23s of the second side wall 23. In other words, the first piece portion 14a is inserted between two of the second piece portions 23a, the two second piece portions 23a being adjacent to each other. In the illustrated wire harness 1, the dimension of the gap 23s in the extending direction X is equal to the width of the first piece portion 14a or slightly larger than the width of the first piece portion 14a. Therefore, the first piece portion 14a enters between the two second piece portions 23a and meshes with the second side wall 23.

In the illustrated wire harness 1, the first piece portion 14a and the second piece portion 23a are alternately aligned along the extending direction X. The plurality of first piece portions 14a and the plurality of second piece portions 23a are aligned on the same line in the extending direction X. That is, the first side wall 14 and the second side wall 23 are combined to form one partition wall extending in a straight line shape in the extending direction X. When the first piece portion 14a and the second piece portion 23a are aligned on the same line in this manner, the gap between the two cases 10 and 20 will be minimized, or the gap will be substantially absent between the two cases 10 and 20.

FIG. 6 illustrates the flat wiring member 100 placed in the first case 10 and the second case 20. The flat wiring member 100 is placed in the cases 10 and 20 so as to sandwich the first side wall 14 and the second side wall 23 by the first portion 110 and the second portion 120. In other words, the flat wiring member 100 is installed in the first case 10 and the second case 20 so as to allow the first side wall 14 and the second side wall 23 to penetrate through the slit 100s. The plurality of first piece portions 14a and the plurality of second piece portions 23a are aligned in the gap between the first portion 110 and the second portion 120.

In the wire harness 1 of the present embodiment, the first side wall 14 and the second side wall 23 are aligned in a straight line shape to form one partition wall. This makes it possible to reduce the width of the slit 100s in the flat wiring member 100. A wire harness to be examined as a comparative example is a wire harness in which two cases 10 and 20 are arranged in a state where the first side wall 14 and the second side wall 23 face each other in the width direction Y. In the wire harness of the comparative example, a gap in the width direction Y occurs between the first side wall 14 and the second side wall 23. In the wire harness of the comparative example, there is a need to set the width of the slit 100s in accordance with the dimension obtained by adding the thickness of the first side wall 14, the thickness of the second side wall 23, and the gap between the two cases 10 and 20.

In contrast to this, in the wire harness 1 of the present embodiment, the width of the slit 100s can be set based on either the thickness of the first side wall 14 or the thickness of the second side wall 23. For example, when the first side wall 14 and the second side wall 23 have a same thickness t1, the width of the slit 100s may be set based on the thickness t1. Therefore, according to the wire harness 1 of the present embodiment, the yield of the flat wiring member 100 can be improved.

When the flat wiring member 100 has been accommodated in the two cases 10 and 20, a closing process of closing the covers 18 and 24 is executed. In the closing process, the cover 18 of the first case 10 is assembled to the main body 11 while bending the hinge portion 11e. In the closing process, the cover 24 of the second case 20 is assembled to the main body 21 while bending the hinge portion 21e. FIG. 7 illustrates a state where the covers 18 and 24 are closed. The facing wall 18a of the cover 18 covers the first portion 110 of the flat wiring member 100. A facing wall 24a of the cover 24 covers the second portion 120 of the flat wiring member 100.

In the wire harness 1 of the present embodiment, the first case 10 and the second case 20 are configured to allow the first portion 110 and the second portion 120 to extend in a straight line shape as described below. As illustrated in FIGS. 3 and 4, the wire harness 1 has a rotating structure 60 that rotatably couples the first case 10 and the second case 20 to each other.

As illustrated in FIG. 4, at an end of the main body 11 of the first case 10 in the extending direction X, there are provided a first shaft support portion 19A and a second shaft support portion 19B. The first shaft support portion 19A rotatably supports the first rotation shaft 25A of the second case 20. The second shaft support portion 19B rotatably supports the second rotation shaft 25B of the second case 20.

At an end of the main body 21 of the second case 20 in the extending direction X, there is provided a first rotation shaft 25A. At an end of the cover 24 in the extending direction X, there is provided a second rotation shaft 25B. The first rotation shaft 25A protrudes in the width direction Y from the side surface of the main body 21. The second rotation shaft 25B extends in the width direction Y so as to cross the end of the cover 24. Both ends of the second rotation shaft 25B are supported by the second shaft support portion 19B.

In the state illustrated in FIG. 7, a first rotation process of rotating the second case 20 relative to the first case 10 is executed. In the first rotation process, the second case 20 is rotated with respect to the first case 10 about a rotation axis Cx illustrated in FIG. 7 as a rotation center. The rotation axis Cx is a straight line extending in the extending direction X between the two covers 18 and 24, for example. The rotation at this time may be executed by using a jig plate, for example. In this case, the jig plate may include: a main body that supports the first case 10; and a support member that supports the second case 20. The support member is supported by the main body so as to be rotatable about the rotation axis Cx as a rotation center.

The second case 20 is rotated relative to the first case 10 about the rotation axis Cx as a rotation center, and the second case 20 is overlapped with the first case 10. This allows the second portion 120 of the flat wiring member 100 to overlap with the first portion 110 and face the first portion 110. At this time, the intermediate portion 130 of the flat wiring member 100 is bent along the rotation axis Cx.

FIG. 8 illustrates a state where the first rotation process is completed and the second case 20 is overlapped with the first case 10. In the present specification, with respect to the first case 10 and the second case 20, a relative position in which the two cases 10 and 20 overlap in a height direction Z is denoted as an intermediate relative position. In the intermediate relative position, the second portion 120 of the flat wiring member 100 overlaps with the first portion 110 and faces the first portion 110. Note that the height direction Z is a direction orthogonal to both the extending direction X and the width direction Y.

FIG. 9 illustrates a cross section taken along line IX-IX in FIG. 8. The first rotation shaft 25A of the second case 20 is rotatably supported by the first shaft support portion 19A of the first case 10. The first shaft support portion 19A includes: a piece portion 19c erected in the height direction Z; and a locking portion 19d. The piece portion 19c has a slit 19e extending in the height direction Z. The end of the first rotation shaft 25A is inserted into the slit 19e and locked by the locking portion 19d.

The second rotation shaft 25B of the second case 20 is rotatably supported by the second shaft support portion 19B of the first case 10. The second shaft support portion 19B has a slit 19f provided in the first side wall 14 and the facing wall 11g. The end of the second rotation shaft 25B is inserted into the slit 19f and rotatably supported by the first side wall 14 and the facing wall 11g. By inserting the two rotation shafts 25A and 25B respectively into the two shaft support portions 19A and 19B, the first case 10 and the second case 20 are rotatably coupled to each other. This forms a busbar module 400. The busbar module 400 includes the busbars 200 and the wire harness 1 of the embodiment.

FIG. 10 is a diagram illustrating the second rotation process. The second rotation process is executed in a factory in which the busbar module 400 is assembled to a vehicle, etc., for example. As illustrated in FIG. 10, in the second rotation process, the second case 20 is rotated relative to the first case 10 from the intermediate relative position toward a second relative position to be described below. In the second rotation process, the second case 20 rotates relative to the first case 10 about the center axis of the two rotation shafts 25A and 25B as a rotation center.

FIG. 11 illustrates a state where the second rotation process is completed and the two cases 10 and 20 are positioned in the second relative position. In the second relative position, the first case 10 and the second case 20 are aligned in a straight line shape along the extending direction X. In this state, the first portion 110 and the second portion 120 of the flat wiring member 100 are aligned in a straight line shape. In other words, the second portion 120 is positioned on an extension line of the first portion 110 in plan view. In addition, the plurality of busbars 200 are aligned in a straight line shape in the extending direction X. The cover 18 of the first case 10 covers the first portion 110 by the facing wall 18a to protect the first portion 110. The cover 24 of the second case 20 covers the second portion 120 by the facing wall 24a to protect the second portion 120.

The first side wall 14 of the first case 10 guards the first portion 110 of the flat wiring member 100. More specifically, the plurality of first piece portions 14a of the first side wall 14 are aligned in the extending direction X and face the first portion 110 in the width direction Y. The plurality of first piece portions 14a function as protective walls for protecting the first portion 110. The first side wall 14 also guards the first portion 110 so that the first portion 110 does not protrude from the first case 10.

The second side wall 23 of the second case 20 guards the second portion 120 of the flat wiring member 100. The plurality of second piece portions 23a of the second side wall 23 are aligned in the extending direction X and face the second portion 120 in the width direction Y. The plurality of second piece portions 23a function as protective walls for protecting the second portion 120. In addition, the second side wall 23 guards the second portion 120 so that the second portion 120 does not protrude from the second case 20.

As described above, the plurality of first piece portions 14a and the plurality of second piece portions 23a constitute one partition wall while being alternately aligned when the two cases 10 and 20 are positioned in the first relative position. Furthermore, the plurality of first piece portions 14a and the plurality of second piece portions 23a function as a protective wall for protecting the flat wiring member 100 in each of the cases 10 and 20 when the two cases 10 and 20 are positioned in the second relative position. Consequently, the first side wall 14 and the second side wall 23 are configured to achieve both the improvement of the yield of the flat wiring member 100 and the functionality of protecting the flat wiring member 100.

As described above, the wire harness 1 of the present embodiment includes the flat wiring member 100, the first case 10, and the second case 20. The flat wiring member 100 includes the first portion 110, the second portion 120, and the intermediate portion 130. The first case 10 is a case that accommodates the first portion 110, and the second case 20 is a case that accommodates the second portion 120. The first portion 110 and the second portion 120 extend in the same extending direction X and are aligned in a width direction Y orthogonal to the extending direction X. The intermediate portion 130 connects an end of the first portion 110 and an end of the second portion 120 to each other in the width direction Y.

The first case 10 includes: the first support wall 11a that supports the first portion 110; and the first side wall 14 that is erected from the first support wall 11a and extends in the extending direction X. The second case 20 includes: the second support wall 21a that supports the second portion 120; and the second side wall 23 that is erected from the second support wall 21a and extends in the extending direction X. The first side wall 14 has the gap 14s that divides the first side wall 14 into the plurality of first piece portions 14a aligned in the extending direction X. The second side wall 23 is inserted into the gap 14s and is aligned on the same line as the plurality of first piece portions 14a.

In the wire harness 1 of the present embodiment, the second side wall 23 and the first side wall 14 are aligned on the same line. This makes it possible to minimize the gap needed between the first portion 110 and the second portion 120 and improve the yield of the flat wiring member 100.

In the wire harness 1 of the present embodiment, the second side wall 23 has the gap 23s that divides the second side wall 23 into the plurality of second piece portions 23a aligned in the extending direction X. The first piece portion 14a is inserted between two of the second piece portions 23a, the two being adjacent to each other, while the second piece portion 23a is inserted between two of the first piece portions 14a, the two being adjacent to each other. In this case, the first piece portion 14a and the second piece portion 23a are alternately disposed in the extending direction X. Therefore, the plurality of first piece portions 14a and the plurality of second piece portions 23a can mesh with each other.

The flat wiring member 100 of the present embodiment includes the slit 100s formed between the first portion 110 and the second portion 120. The slit 100s extends in the extending direction X. The flat wiring member 100 is disposed so as to sandwich the first side wall 14 and the second side wall 23 by the first portion 110 and the second portion 120. This makes it possible to minimize the width of the slit 100s and improve the yield of the flat wiring member 100.

The configurations of the first side wall 14 and the second side wall 23 are not limited to the configurations exemplified above. For example, the second side wall 23 need not be divided into the plurality of second piece portions 23a. In this case, the first side wall 14 may have at least two first piece portions 14a divided by the gap 14s. The second side wall 23 may be inserted into any gap 14s provided in the first side wall 14 so as to be aligned on the same line as the plurality of first piece portions 14a.

In the above embodiment, the first side wall 14 and the second side wall 23 are configured such that the first piece portion 14a and the second piece portion 23a mesh with each other to form one continuous partition wall. However, the configurations of the first side wall 14 and the second side wall 23 are not limited to such configurations. For example, a gap may be provided between the first piece portion 14a and the second piece portion 23a. In this case, the partition wall formed by the first side wall 14 and the second side wall 23 may include a plurality of gaps.

In the above embodiment, the case having the shaft support portions 19A and 19B is denoted as the first case 10, and the case having the rotation shafts 25A and 25B is denoted as the second case 20. However, the notations of the two cases are not limited thereto. For example, the first case 10 may be a case having the rotation shafts 25A and 25B, and the second case 20 may be a case having the shaft support portions 19A and 19B. That is, regarding the side walls provided in the two cases 10 and 20, it is sufficient to have a configuration in which either one of the side walls is divided into a plurality of pieces and the other side wall can be inserted into the gap between the one side wall.

Note that the flat wiring member 100 is not limited to the FPC. The flat wiring member 100 may be another flat wiring member such as a Flexible Flat Cable (FFC), for example.

The contents disclosed in the above embodiment can be executed in appropriate combination with each other.

In the wire harness according to the embodiment, the first side wall of the first case has a gap that divides the first side wall into a plurality of first piece portions aligned in the extending direction, and the second side wall of the second case is inserted into the gap and aligned on the line same as the line of the plurality of first piece portions. According to the wire harness of the embodiment, there is an effect that the yield of the flat wiring member can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a flat wiring member including a first portion, a second portion, and an intermediate portion;
a first case that accommodates the first portion;
a second case that accommodates the second portion;
wherein the first portion and the second portion extend in a same extending direction and are aligned in a width direction orthogonal to the extending direction,
the intermediate portion connects an end of the first portion and an end of the second portion to each other along the width direction,
the first case includes: a first support wall that supports the first portion; and a first side wall that is erected from the first support wall and extends in the extending direction,
the second case includes: a second support wall that supports the second portion; and a second side wall that is erected from the second support wall and extends in the extending direction,
the first side wall has a gap that divides the first side wall into a plurality of first piece portions aligned in the extending direction, and
the second side wall is inserted into the gap and is aligned on a same line as the plurality of first piece portions.

2. The wire harness according to claim 1,
wherein the second side wall has a gap that divides the second side wall into a plurality of second piece portions aligned in the extending direction,
each of the first piece portions is inserted between two of the second piece portions, the two being adjacent to each other, and
each of the second piece portions is inserted between two of the first piece portions, the two being adjacent to each other.

3. The wire harness according to claim 1,
wherein the flat wiring member has a slit formed between the first portion and the second portion and extending in the extending direction, and
the flat wiring member is disposed so as to sandwich the first side wall and the second side wall by the first portion and the second portion.
